(19) United States
(12) Patent Application Publication
(10) Pub. No.: US 2022/0090538 A1
(43) Pub. Date: Mar. 24, 2022

(54) Zero Emissions Turbofan [With Aeroderivative Power Generation and Marine Applications]

(71) Applicant: James Hall Carrow, Riverside, CA (US)

(72) Inventor: James Hall Carrow, Riverside, CA (US)

(21) Appl. No.: 17/027,068

(22) Filed: Sep. 21, 2020

(51) Int. Cl. F02C 3/24; F02C 7/22; F02C 7/06; F02C 6/20; F02C 7/16

(52) U.S. Cl. CPC F02C 3/24; F02C 7/22; F02C 7/06; F05D 2260/60; F02C 7/16; F05D 2260/232; F05D 2260/98; F02C 6/203

(57) ABSTRACT

This is an application for a utility patent for a zero emissions turbine, suitable for use in aerospace, power generation, industrial, and marine applications, that runs on the combustion of liquid hydrogen and liquid oxygen and which is cooled by liquid oxygen. It is unique in that its only emissions will be steam, water vapor, pure oxygen, and ice crystals, with no pollutants or greenhouse gases of any kind. It is also unique in that it uses no air intake, no compressor, and simplified shaft and auxiliary drive systems. It has a unique tank and pump system that runs on electric motors and specialized lubricating systems. These turbines can be designed with powerful and reliable operating specifications with greatly reduced fuel consumption and greatly improved power-to-weight ratios.

### CROSS-REFERENCE TO RELATED APPLICATIONS

The inventor currently has two other USPTO utility patent applications that are awaiting examination, Utility patent application Ser. No. 17/093,042, Zero Emissions Marine Engine, and Utility patent application Ser. No. 17/026,205, Zero Emissions Power Generation Boiler. Neither one conflicts in any way with this application.

### STATEMENT REGARDING FEDERALLY-SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### Field of the Invention

The inventor, James Carrow, first began working on designs for his company, North River Energy LLC, in 2001. The original design was for a zero emissions diesel engine, and this was followed by designs for liquid hydrogen and liquid oxygen production, processing, and transport facilities and a combined cycle power plant using zero emissions boilers and turbines. A provisional application for a utility patent for one version of the diesel design was submitted to the U.S. Patent and Trademark Office in the spring of 2008, but as the design was changing rapidly at the time no actual utility patent was applied for the following year. Designs for the zero emissions diesel and the zero emissions combined cycle power plant, including zero emissions boilers, turbines, and a cogeneration system, were submitted to the California Energy Commission for grants in late 2008 and early 2009 but did not receive financing at that time. In late 2009 inventor began posting renderings of his designs on his North River Energy business site. The diesel design, in a zero emissions truck project, along with renderings of the production, process, and transport facilities, appeared in December, 2009. Renderings of a zero emissions off-road motorcycle appeared on the site in late 2011. Renderings of the zero emissions power plant boiler system appeared on the North River Energy business site in the spring of 2012. A later version of the zero emissions truck, in the form of a garbage truck, appeared on the business site in 2013. Renderings of a zero emissions marine engine appeared online in 2014. Renderings of the zero emissions turbofan appeared on the North River energy business site in January, 2018, in a cargo jet design. More detailed renderings of the turbofan were posted online in 2019. At this time the North River Energy business site includes renderings of the aerospace version of the turbofan, the zero emissions power plant boiler system, the zero emissions diesel truck design, and a proposed wind energy project. These can be found at the North River Energy LLC business site at northriverenergy.us. In addition, the inventor has also done quite a bit of work over the past two decades on improved cryogenic fuel tank designs, some of which have been posted online over the past two years.

These designs are all based on the production, transport, storage, and combustion of liquid oxygen and liquid hydrogen, which produces steam, water vapor, and ice crystals as emissions, with no contaminating elements. This process was first employed as part of a Defense Advanced Research Projects grant to Convair Corporation of San Diego, Calif., back in the 1950s, which resulted in NASA's Centaur rocket stage program, a design which is still being used by space missions today, over 60 years later. Work from that design process was later incorporated into the Saturn and space shuttle rocket programs and several other American rocket launch vehicles, including the new Space Launch System rockets, and has also been used very successfully by the Arianespace program and JAXA, the Japanese Aerospace Exploration Agency.

For one reason or another this work has not translated into power plant, truck, ship, train, or aircraft designs. The use of liquid oxygen as an oxidizer in rockets dates back to original research done in this country by Dr. Robert Goddard, and he held the original patent for liquid-fueled rockets that was granted by your predecessors all the way back in 1914. His work was later copied by the Axis powers in World War II, the rocket designs of the former Soviet Union and their successors in Russia today, and by NASA, and is currently used by NASA, the Russians, several other space agencies, and by the SpaceX, Virgin Galactic, and Blue Origins space projects, over a century after the filing of that original patent.

Today hydrogen is routinely used as a generator system coolant by major power plants and utility companies all over the world, and it is also routinely used in massive quantities by every major oil refinery in the world as part of the gas and oil refining business. In addition, oxyhydrogen welding equipment, which combines streams of oxygen and hydrogen gas, has now been used successfully for more than half a century, and continues to be used wherever either a cleaner flame, finer quality work, or underwater welding is required and is often used to weld aluminum due to its somewhat lower combustion temperature than oxyacetylene and arc welding techniques.

The “zero emissions” concept is one that arrived about two decades ago, as concerns about the negative effects of harmful emissions and greenhouse gases began to increase. The efforts to control emissions in this country date all the way back to the 1950s, and have resulted, over the past six decades, in many government agencies, worldwide, and many different enforced emissions standards for transportation, power generation, and industrial processes, to a point today where most engines and power generation facilities are subject to these rules and have to undergo emissions testing. “Zero emissions” means no harmful, dangerous, banned, or illegal emissions, rather than no emissions at all. Therefore, individual atmospheric gas molecules are not considered “emissions” in the sense of this term, nor are completely harmless substances like water vapor, steam, or ice crystals. The Collins English Dictionary online defines the term with the phrase “a zero-emission vehicle does not produce any dangerous gases”. The Random House Unabridged Dictionary of the English Language online uses the phrase “a vehicle, as an automobile, that does not directly produce atmospheric pollutants.[Abbr.:] ZEV”. The Oxford English Dictionary uses the phrase “Denoting a road vehicle that emits no pollutants from its exhaust.” The phrase is used worldwide, at this time, and routinely appears in publications, broadcasts, legislative committee meetings and votes, political speeches, and new published standards for transportation, power generation, and industrial processes.

This application is for an aerospace turbofan with aeroderivative power generation and marine applications. An “aeroderivative” design, in the turbine industry, is one that is based on an aerospace design, but with some small modifications that make it more suitable to its specific use. The term is routinely used by major manufactures like General Electric, who sell ‘aeroderivative” power generation turbines, and Rolls-Royce, which also sells “aeroderivative” power generation turbines along with their marine turbines. Turbines are like internal combustion piston-driven engines, they produce work in the form of a rotating axle that creates a combination of horsepower and torque at different rates of “rpm” (revolutions per minute). The load to which that axle is attached really does not matter in the least, other than the fact that some engines work better at a specific rpm, like power generation systems that are designed to work at 1800 or 3600 rpm, truck diesels that achieve maximum efficiency at 1800 rpm, or aircraft turbofans, turboprops, and turbojets whose speed is limited by the speed of their fans or propeller tips, which can go supersonic if the rpm is too great. Gas combustion turbines are found today in power plants all over the world, in industrial settings, on ships, including the latest U.S. Navy destroyers, the Zumwalt class, which run on indirect drive powered by two Rolls-Royce gas turbines, on the U.S. Army's current main battle tank, the Abrams M1 tank, which is powered by Honeywell gas turbines, and on most aircraft in one form or the other. But they all work due to the fact that compressed gases or steam pass through turbine blades, spinning the axle and creating horsepower and torque. Most turbine designs can be used for multiple applications as a result, as long as they have the necessary modifications in size, weight, cooling, and electronics, along with, in many cases, today's modern emissions control hardware and software. This particular utility patent application is for a specific zero emissions gas turbine and combustor design, without the normal air intake and compressor, accompanied by specific pumping, cooling, and electrical motor systems. What it is attached to really does not matter, in that sense.

### Description of Related Art Including Information Disclosed Under 37 CFR 1.97 and 1.98

In this original patent application in late 2020 the inventor requested and paid for a patent application search. The response, received this past summer, in 2021, was a list of 6 U.S. patents and 7 U.S. patent applications, none of which appear to have anything to do with the current application other than some vague resemblance to one or another of the constituent parts of the design presented. Five of the six patents, all issued before 2001, are no longer in force. However, one of those patents and four of the applications were used to dismiss the claims, so they will be listed and discussed, one by one. Some older patent like the 1914 Goddard patent, which has literally defined the face of the entire rocket industry for over a century, and which has resulted in tens of thousands of successful designs, variations, and launches over the years, might have been a more appropriate citation. It does not appear as though any of the 13 applications and patents cited has resulted in a successful design of any kind to date.

1. Hans Lifka, USPTO utility patent number U.S. Pat. No. 5,014,508-A, issued May 14, 1991, “Combination propulsion system for a flying craft”. First off, this patent expired over ten years ago. Second, it may be that no working model was ever produced. Nor would one ever work, just based on the drawing and description available in a USPTO patent search. This is a design for a combination rocket engine, ramjet, and turbofan that runs on liquid hydrogen and liquid oxygen. There is little question that the ramjet is an unworkable design. Its design features high-pressure air passing through fuel lines in front of the fan, then passing through the fan itself, and finally passing through the compressor blades, which the inventor claims will be “feathered” for this use. How does this design “feather” the fan blades while still using them for forward propulsion? There is no answer to that question. The rocket engine contains turbine blades in its combustion chamber and no cooling, and thus is also probably an unworkable design. The turbofan design is a twisting, winding affair with cryogenic fuel entering through the front of the engine and the middle of the fan, with two U-turns along its route and a combustion chamber behind the turbine blades where the fuel is mixed with air, which also serves as the ramjet's combustion chamber. The design shows no apparent fuel storage, fuel pumps, cooling or lubrication of any kind, and what may be an impossible sealing job that includes seals on the “feathering” compressor and turbine blades and several other areas. The jet exhaust of the turbine ends up in a passage that is much smaller than the last turbine stage. The concept appears to have been an aircraft engine that can attain hypersonic speeds, and there may actually be a workable design out there that has lost the ramjet part of this design. This one is not it. The low speed part of this engine is labeled a “turbofan” but only bears a very slight resemblance to a working turbofan. It is by no means a design for a turbofan that would actually work in practice. In addition, this is not a “zero emissions” engine by any means, as it uses an air intake and compressor along with its hydrogen and oxygen fuel, which would create harmful emissions including ammonia, nitrogen dioxide, and nitrous oxide, among other things. Finally, the application for this patent occurred about 30 years after the Centaur project began at Convair corporation back in the 1950s, and long after the design of the NASA's Saturn rockets, Space Shuttle rockets, and Delta rockets and Arianespace's rockets, all of which have used liquid hydrogen and liquid oxygen as fuel. As such, the rocket design is hardly original work.

2. Monte Douglas DeWitt, USPTO patent application publication number US-20100314878-A1, published Dec. 16, 2010, “Direct generation of steam motive flow by water-cooled hydrogen-oxygen combustion:”. First, this is actually an application for a patent for a steam boiler system, not for any form of gas turbine, and as such it has nothing to do with the current application. Second, it was filed in June, 2009, a few months after the submission of North River Energy's design for practically the same water-cooled steam boiler and turbine system running on liquid hydrogen and liquid oxygen to the California Energy Commission, as part of a proposed combined cycle power plant design. As such it appears to be a copy as the inventor has no apparent background of any kind in this field. The design drawing in the USPTO file clearly shows a line and two valves in between the boiler system and the turbine system, so this is far from the design of a power generation combustion turbine. As such it is not suitable for any kind of aerospace application. There have been steam boilers used on ships (the Titanic went down with a system like that, for instance) and they are used in power plants, but the North River Energy design here is for the type of combustion turbine used by power generation companies for peaking power and in combined cycle plants, a totally different thing, as are the combustion turbines used in many modern naval ships and the turbofans, turbojets, and turboprops used in aircraft.

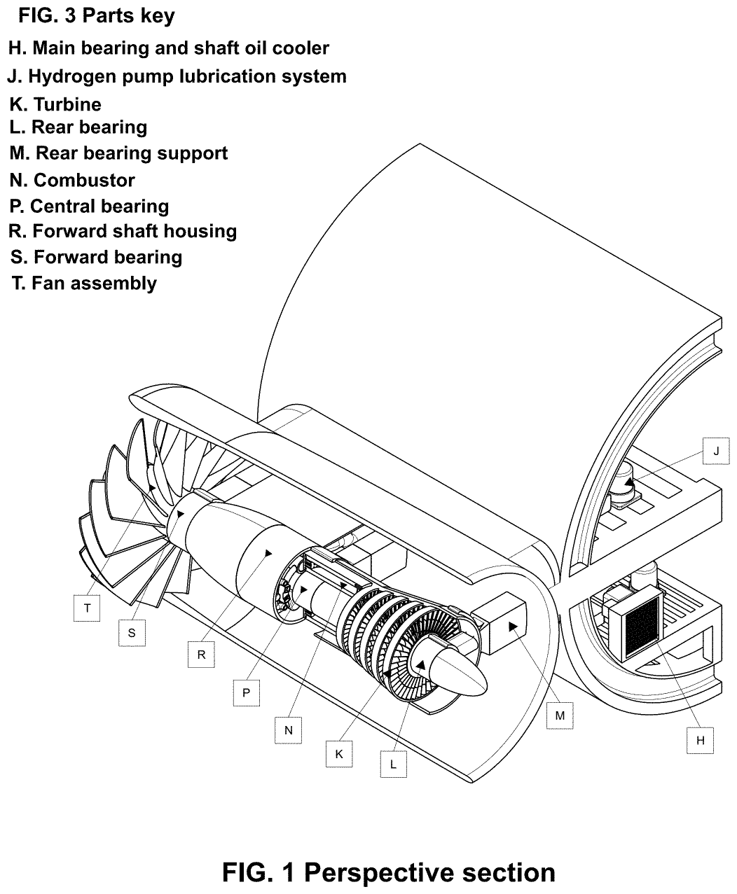

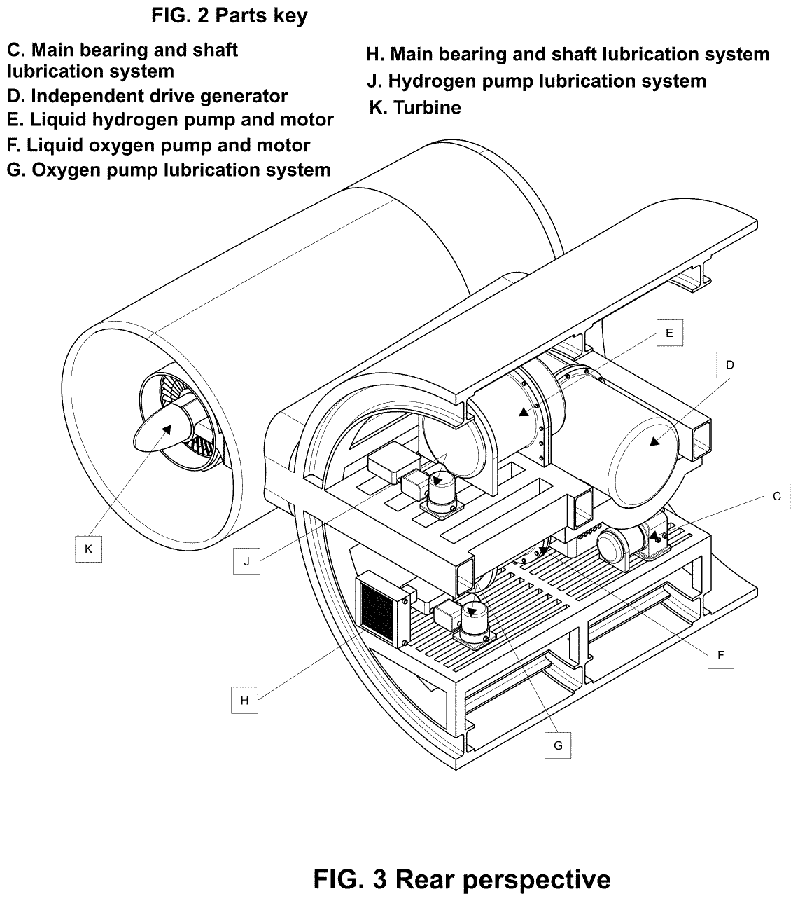

3. Marius Angelo Paul, USPTO patent application publication number US-20120110976-A1, published May 10, 2012, Universal, Aerospace, Naval Eternal Technology Systems. It is very difficult to ascertain from the claims, description, drawing views, and drawing available exactly what this design is and is not. At various times in describing the drawings the inventor claims that he is showing a turbofan and turbo compressor with centrifugal concentric gas turbine (the illustration shown by USPTO, drawing number 1), ram rocket (the next three drawings), turbojet rocket (drawing 5), turbo fan-air, turbojet, and turbo rocket (drawings 6-10), a universal wingless tailless featuring two universal aero space engines, multi-turbojet, ramjet, and turbo rocket (drawings 11-14), and a universal mobility fire fighter wingless tailless with turbojets and turbo rockets which the inventor claims could have been used to save all of the unfortunate victims of the 9/11 incident. The basic designs appear to include an air intake and a compressor, which he mentions literally dozens of times (for instance, “[0080] The combustion and energy generation module B, is including the group of double or four free counter rotating gas turbo compressor rotors 110 and 111, described in the FIG. 1, and FIG. 3”) which would clearly differentiate that part of his presentation from the North River Energy design. He does mention liquid oxygen cooling, but in combination with air and in the compressor by means of injection, which is far different than the liquid oxygen cooling system of North River Energy, which cools the interior walls of the combustion chamber and first row of stators both by means of pumping liquid oxygen through internal cooling passages and by the use of liquid oxygen film cooling, which enters through the edges of combustor head, and also by fuel cooling, which cools the combustion process itself by means of adding extra liquid oxygen to the liquid oxygen/liquid hydrogen fuel ratio. The vast number of often conflicting Paul claims only describe adding liquid oxygen to the incoming air in the compressor, on the other hand. These are two completely different systems, at least in the turbofan/turbojet descriptions. The ramjet, the rocket, the turbo rocket, and the “nuclear-electric” fuel production systems described by Paul are all apparently totally different designs and projects, as is the wingless tailless aircraft. The “turbofan” he shows in drawing one, with its extremely odd air intake, curving “free counter rotating” air compressor system, and winding turbine with a curved axle leading nowhere, especially not to a fan, is neither workable nor is it anything even close to a “zero emissions” design. The guess is that no working models of any of these designs have ever been attempted or produced.

4. Hyun Duk Kwak et al., USPTO patent application publication number US-20180230948, publication date Aug. 16, 2018, “Liquid Rocket Engine Using Booster Pump Driven by Electric Motor”. This is apparently a submission by employees of the Korean Aerospace Research Institute. First, this is purely a rocket engine design, it is not a turbine design. Second, it is just an idea for battery-powered fuel line booster pumps, near the fuel tanks, not a modification of the now-standard main turbopump used to pressurize liquid fuel prior to entering the rocket combustion chamber, which is included by the inventors right in the middle of the drawing shown on the USPTO site. In the North River Energy design both the main fuel pumps and the fuel line booster pumps (the latter not shown) are driven by electric motors powered by a large independent drive generator with a power take-off from the main turbine axle, after being started up by an auxiliary power unit (APU) during the initial start-up phase. The APU would contain a battery for starting; other than that there is absolutely no similarity at all between the two designs. Third, this design is aimed at rocket combustion that often lasts a matter of minutes; batteries are not a solution for combustion turbines that run for hours, days, and weeks at time, except during their very brief start-up routines. Current aircraft normally use both APUs and independent drive generator systems linked to their turbofans, turboprops, and turbojets, and their fuel pumps are often mechanically linked to the engine shafts by means of an auxiliary drive system. The difference is that they are not cryogenic fuel lines and fuel pumps, as in the North River Energy design, nor are they pumping highly pressurized cryogenic fuel into their coolant systems. Almost all modern aircraft use air-cooled engines instead.

5. Kevin Dittmar et al., USPTO patent application publication number US-20190308741-A1, published Oct. 10, 2019, “Micro-Auxiliary Power Units”. This appears to be an application submitted by employees of Honeywell International. The design is for an auxiliary power unit (APU) powered by a Wankel rotary engine. The drawing available on the USPTO site is not scaled but the word “micro” in the title suggests that it is on the smaller side, as APUs go. It is not clear what this has to do with the North River Energy application, because there is no attempt in this application to patent APUs. They are already commercially available in all sizes and power outputs. In fact, any home or business back-up power generator could also be called an “APU’ in that sense. Nor is the North River Energy application an attempt to patent independent drive generators, electric motors, cryogenic fuel pumps, oil pumps, oil coolers, or oil filters. They are all out there on the market right now, although the project will probably require custom-designed pumps.

### SUMMARY OF THE INVENTION

This invention is a zero emissions turbine capable of being used for several different purposes: 1) as an aerospace turbofan; 2) as an aeroderivative power generation turbine; 3) as a marine direct drive turbine; 4) as part of marine gensets in indirect drive systems; and 5) in industrial processing and production applications. There would be stronger construction and an inline generator in the power generation version; lighter weight and smaller size in the marine genset version; lighter weight, a fan, and a linked independent drive generator (IDG) in the aerospace version; and a propeller shaft and gearbox in the marine direct drive version.

The design involves burning liquid hydrogen and liquid oxygen in a combustor, with part of the liquid oxygen used as fuel cooling, film cooling, and combustor wall and stator cooling. The expansion from gasification and the production of heat in the combustor creates pressure which is then translated into power by means of passing through successive turbine blade stages connected to a fan, generator, or drive shaft by means of a single main shaft running on a bearing system. In the aerospace version the exhaust is vented out the rear, and becomes part of the propulsion system; in the power generation version it would normally be vented to a condenser unit and then up a stack; in the marine versions it would be vented up a stack or out the aft end of the ship. The main shaft in the aerospace version is connected to an independent drive generator system that produces the power needed by the fuel pumps and electronics. In the power generation and genset versions that power is produced by the generator.

### DRAWING VIEWS

The drawings are design development drawings which show the major components but which do not show nuts and bolts, welds, sensors, actuators, engine control units (ECUs), electronic harnesses, buses, and interfaces, most wiring, engine controls and displays, seals, bearing sections, and some of the smaller piping connections. Material types are not shown. In the aerospace version, these materials would be aircraft aluminum alloys, titanium/aluminum alloys, stainless steel alloys, nickel and chromium alloys, modern turbine blade and stage alloys and materials, modern bearing alloys and materials, modern sealing system alloys and materials, and modern fan composites and alloys. In the power generation version, many of the lighter aluminum and titanium elements would be replaced with heavier steel and nickel alloys, and the same can be true in marine versions. Some versions may include modern turbine blade coatings.

The alternators, generators, independent drives, electric motors, and APUs are designed as standard modern versions, for the most part, as are many of the sensors, actuators, valves, pumps, filters, and fuel lines. The three separate lubrication systems, for the main bearings and shaft, the hydrogen pump, and the oxygen pump, all require their own specialized lubricants. The fuel tanks will be a custom highly-insulated temperature controlled design with multiple pressure relief valves, a cooling system, a boil-off re-liquefaction system, and a tank and fuel line purging system.

The drawings are a revision of the original set submitted in this application, as requested by the USPTO.

Drawing 1, labeled FIG. 1 Perspective section, is a cutaway perspective section showing the turbine in its aerospace version, with sections taken through the nacelle, the turbine casing, the combustor, and the fuselage. The 5 turbine stages, the 3 main bearings, the fuel line feeds to the combustor, and the combustor walls with coolant passages can clearly be seen.

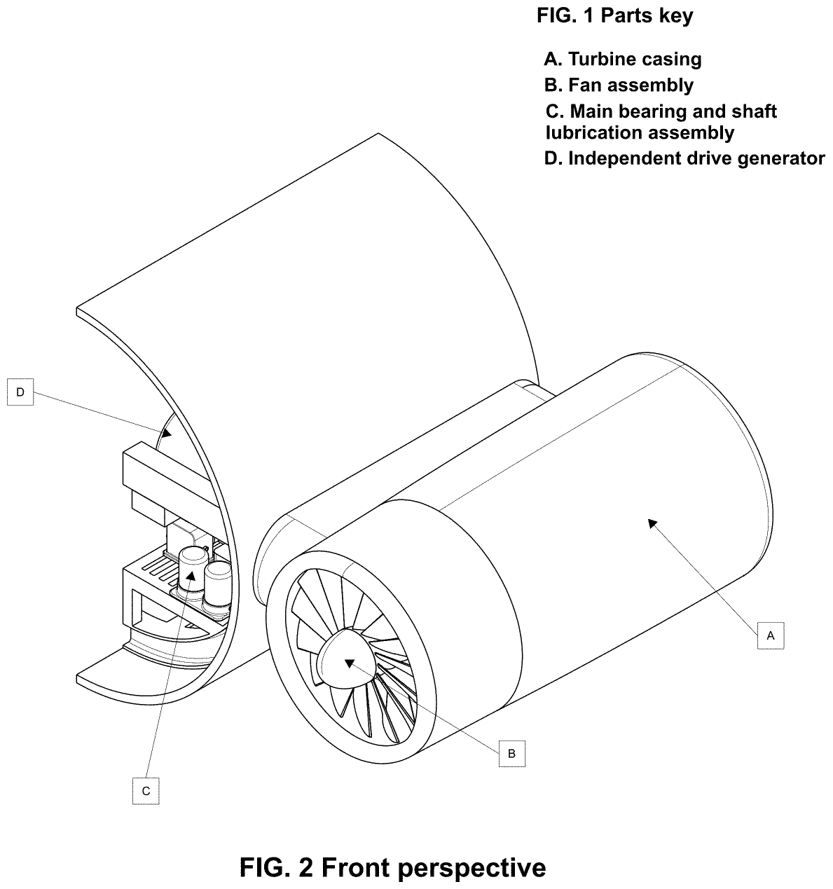

Drawing 2, labeled FIG. 2 Perspective, is a perspective rendering from the left front of the aerospace version showing the fan and the complete nacelle along with a section through the fuselage.

Drawing 3, labeled FIG. 3 Rear perspective, is a perspective rendering from the right rear of the aerospace version showing a section of the fuselage with the independent drive generator, the hydrogen pump and its electric motor, and the lubrication systems.

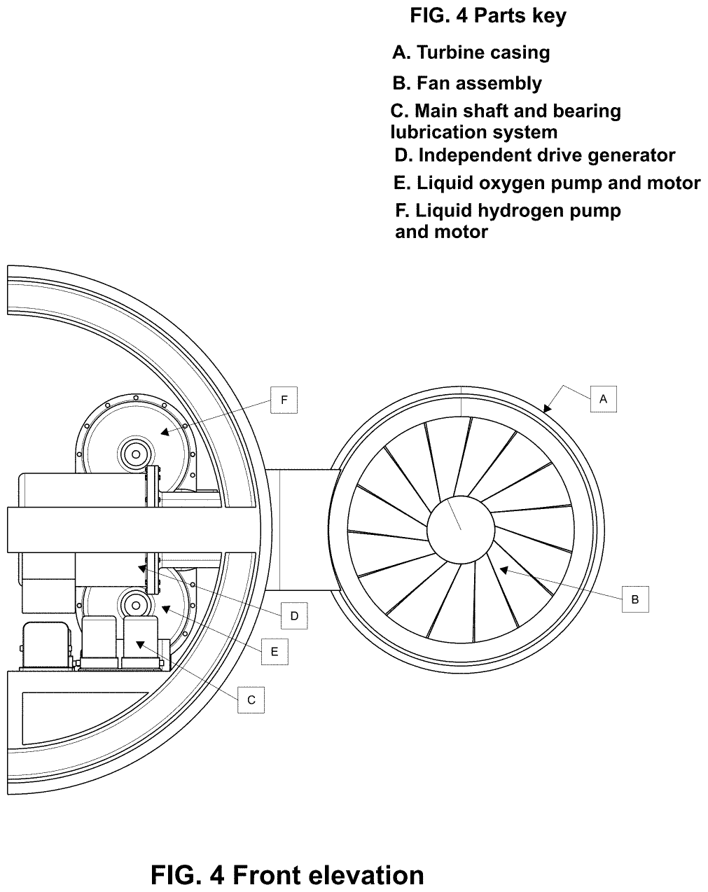

Drawing 4, labeled FIG. 4 Front elevation, is a frontal view of the aerospace version and section through the fuselage that shows the fan, the independent drive generator, the hydrogen pump, the oxygen pump, and the main bearing and shaft lubrication system.

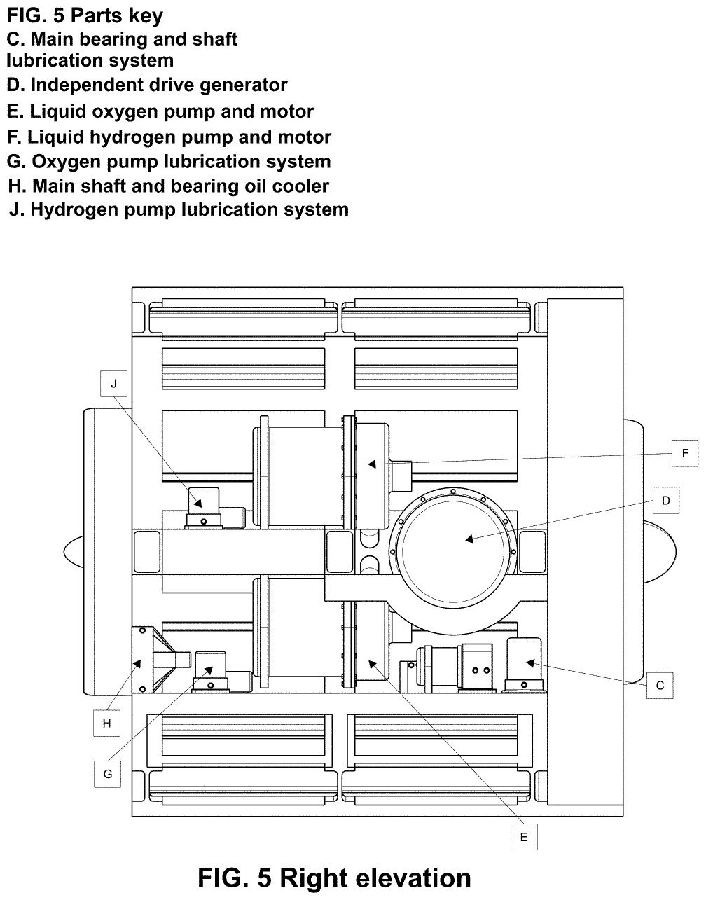

Drawing 5, labeled FIG. 5 Right elevation, is a section through the fuselage showing the independent drive generator, the hydrogen pump and its electric motor, the oxygen pump and its electric motor, the main bearing and shaft lubrication system, the oxygen pump lubrication system, and the hydrogen pump lubrication system.

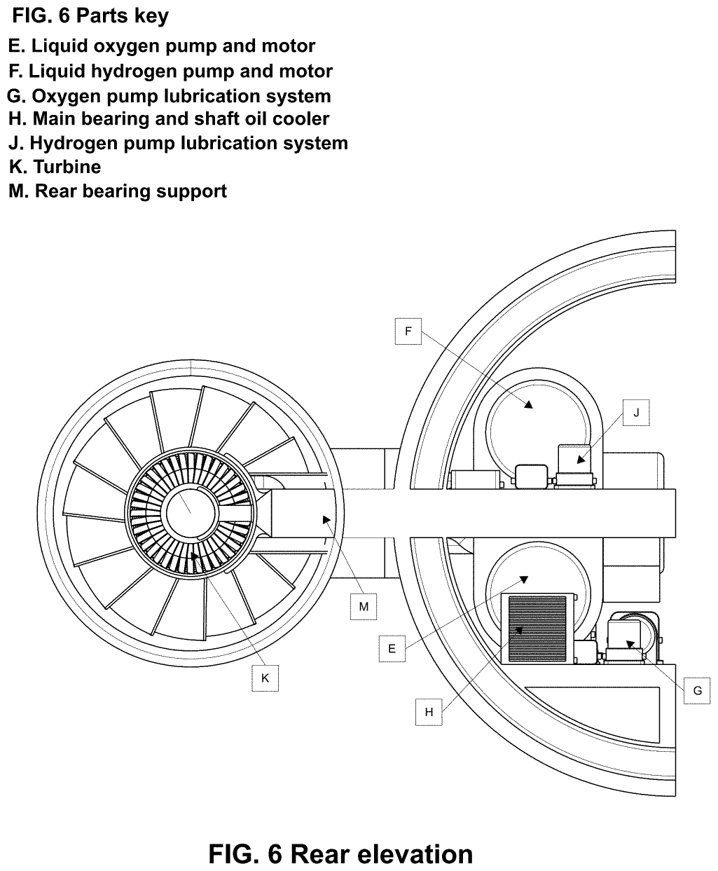

Drawing 6, labeled FIG. 6 Rear elevation, shows the rear of the turbine system and a section through the fuselage showing the main oil cooler, the oxygen pump electric motor, the hydrogen pump electric motor, the oxygen lubrication system, and the hydrogen lubrication system.

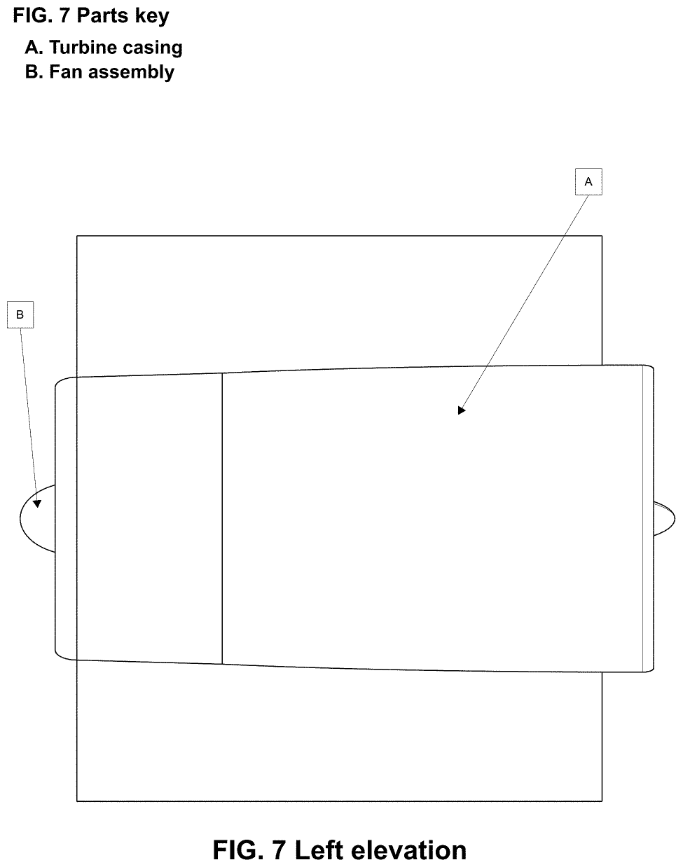

Drawing 7, labeled FIG. 7 Left elevation, shows the left side of the nacelle and front end of the fan.

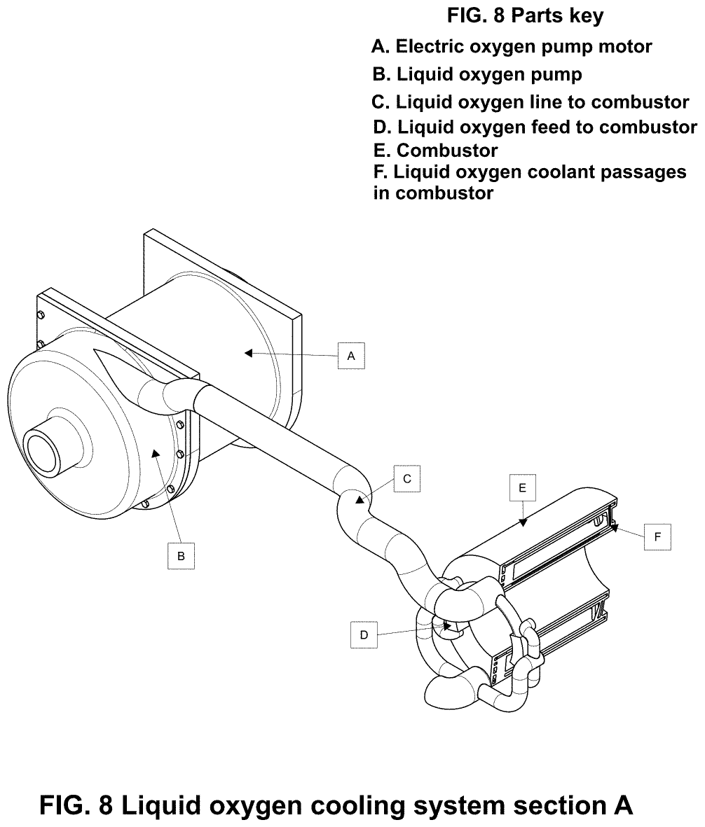

Drawing 8, labeled FIG. 8 Liquid oxygen cooling system section A, is a perspective rendering and perspective section of the liquid oxygen cooling system, showing the liquid oxygen pump and its electric motor, the fuel line leading to the combustor feed system, and a cutaway section of the combustor showing the coolant passages running through the inside wall of the combustor, the stators, and the outside wall of the combustor, before sending the liquid oxygen back into the combustor itself.

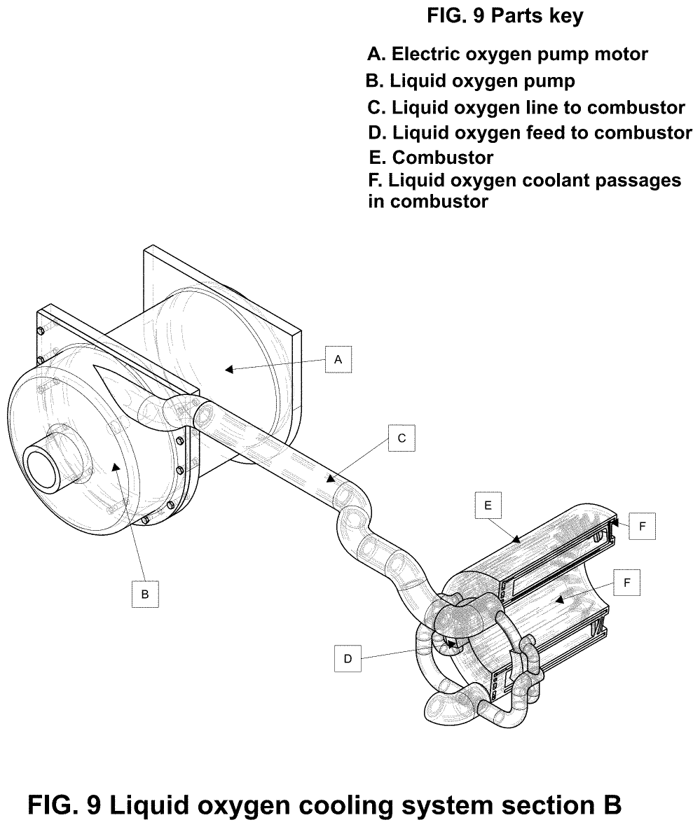

Drawing 9, labeled FIG. 9 Liquid oxygen cooling system section B, is the same perspective rendering and perspective section as FIG. 8 but with the addition of lighter lines representing hidden interior spaces and objects that show the insulated double-walled vacuum-jacketed pipe used in the fuel lines and the fuel feeds to the combustor and the liquid oxygen coolant passages completely encircling the main chamber of the combustor.

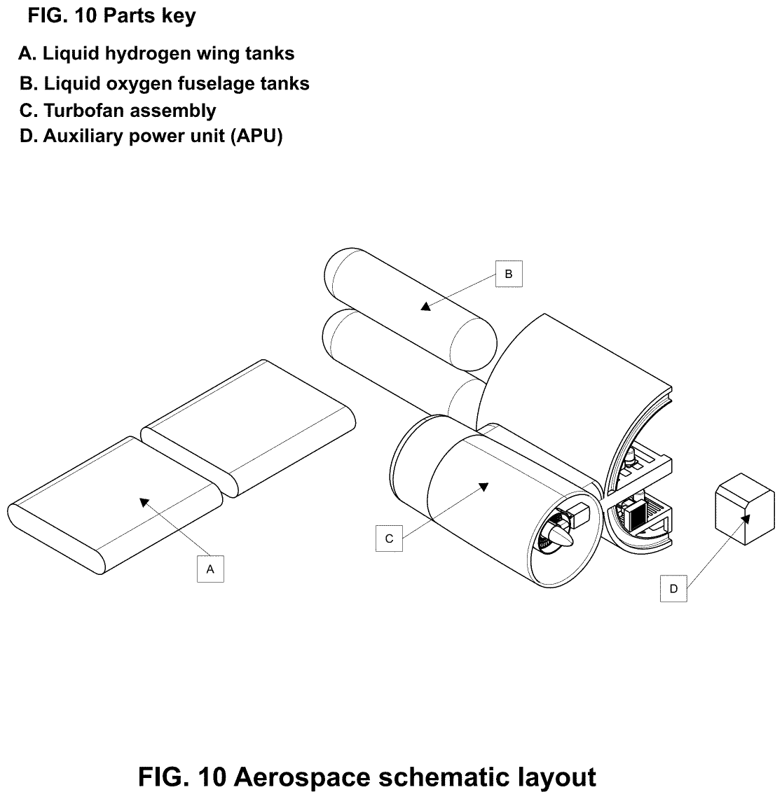

Drawing 10, labeled FIG. 10 Aerospace schematic layout, is a schematic perspective rendering and perspective section of the major components of a typical aerospace set-up, including the turbofan, liquid hydrogen wing tanks, liquid oxygen fuselage tanks, and an auxiliary power unit (APU) at the rear.

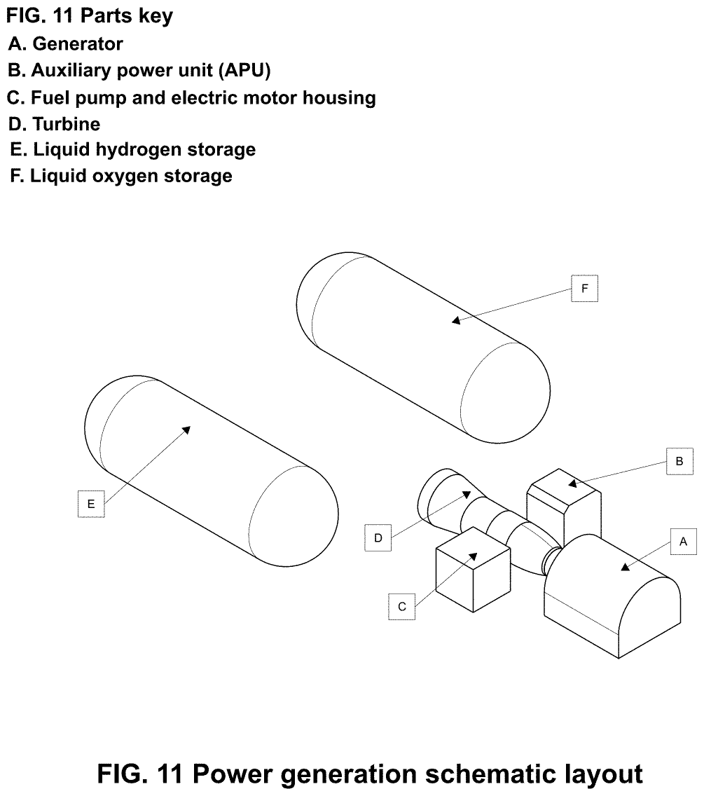

Drawing 11, labeled FIG. 11 Power generation schematic layout, is a schematic perspective rendering of the major components of a typical power generation set-up, including the turbine, the generator, the pump, electric motor, and lubrication system housing, the liquid hydrogen tank, the liquid oxygen tank, and an optional APU.

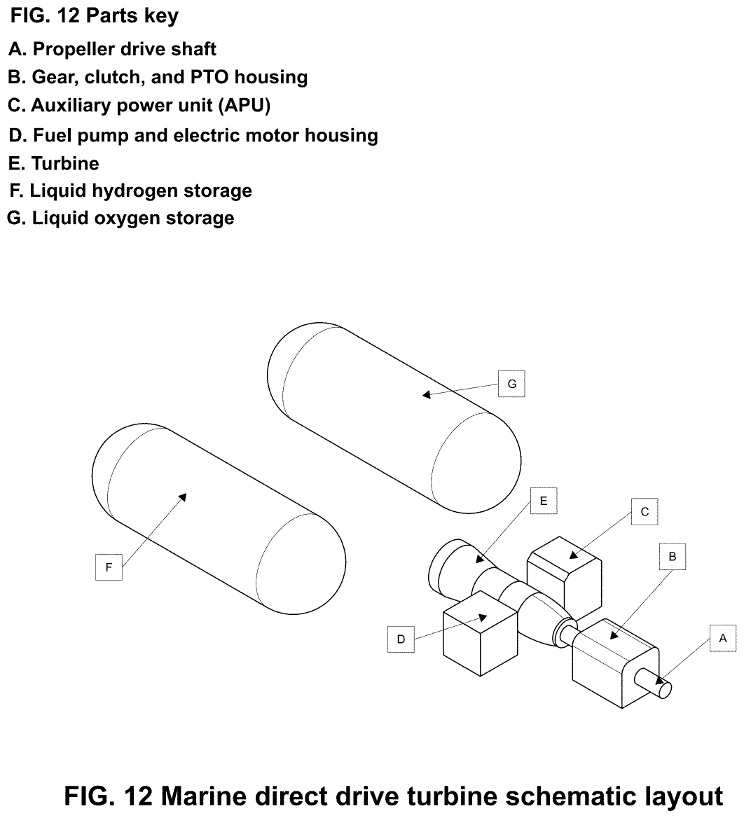

Drawing 12, labeled FIG. 12 Marine direct drive turbine schematic layout, is a schematic perspective rendering of the major components of a marine direct drive system, including the turbine, the main shaft, the gear, clutch assembly, and optional power take-off housing, the pump, electric motor, and lubrication system housing, the liquid hydrogen storage tank, the liquid oxygen storage tank, and an optional APU.

### DESCRIPTION OF THE INVENTION

This turbine design is unique in its use of fuels, its construction, and its performance. It burns two cryogenic fuels, liquid hydrogen and liquid oxygen, in its combustor to create pressure that spins turbine stages which rotate a central shaft to create power. In that way it is similar to thousands of modern gas turbines, but that is where the similarity ends. This design has no air intake whatsoever, for one thing. In aerospace versions, that means that potential power is limited only by weight and by the lift and drag on the engines, wings, tail, and fuselage, and is not limited by altitude other than by the effect of decreasing air pressure in the fan, giving this design a large edge on modern jet turbofan designs. In marine versions, that means that this design can operate in any kind of weather, at any temperature, and at any depth, if required.

This design uses no compressor whatsoever, unlike every other working gas turbine design in the world today, relying instead on the gasification and expansion during combustion of its two fuels for power. That is an absolutely massive advantage over any other gas turbine, a real game-changer. It is a bit difficult to predict the exact size of that advantage in numbers prior to tests of actual working models, but based on available figures for the thrust-specific fuel consumption of different types of existing aerospace engines, it may increase the available thrust per pound of fuel by an estimated factor of about ten or so, and that same factor would also apply to turbines used for power generation, marine direct and indirect drive systems, and industrial processing. Modern jet turbofans often require as many as three separate shafts to drive the fan and the compressor along with a large auxiliary drive shaft for everything else. Power generation and marine turbines can also employ multiple shafts. This design requires one shaft for the fan and one auxiliary drive for the independent drive generator. The simplified design saves about half of the weight of the turbine itself by eliminating the extra shafts, extra bearings and seals, and all of the compressor stages. These changes unlock a whole new world of power production and fuel economy for gas turbines, along with a whole new world of potential range for jet aircraft.

The similarity with rocket engine designs has been noted above. However, in place of turbopumps pressurizing the fuel lines, which have now been standard in rocket design since the days of rocket pioneer Robert Goddard back in the 1920s, this design uses pumps driven by electric motors to create pressure in the lines and the combustor head. The somewhat greater weight of those pumps and the generator is offset by their independent speed controls and their zero to 100 percent speed range, creating a whole new world of fuel pressure control in this design. It means that pre-cooling and start-up procedures should be able to run without a hitch in this model, and it makes long-term continuous running, for hours, days, weeks, and months at often variable rates not only possible but entirely practical. In addition the design employs three separate lubrication pump and filter designs, one each for the main bearings and shaft, the liquid hydrogen pumps, and the liquid oxygen pumps.

Most rocket designs that burn these two fuels use liquid hydrogen cooling to save weight. This design uses liquid oxygen, a heavier and somewhat less efficient coolant, but one with a much, much wider usable temperature range and an emission, pure gaseous oxygen, that is not a pollutant, unlike rockets which can produce ammonia and methane in their exhausts. The liquid oxygen is pumped at high pressure through coolant passages in the interior wall of the combustor, then through the first stage of turbine stators to the coolant passages in the outside wall prior to entering the combustor and burning with the liquid hydrogen. It is also added through film cooling holes along the outside edges of the combustor head. In addition a fuel cooling system, which adds additional liquid oxygen to the ratio of the liquid hydrogen to liquid oxygen to help control the combustion temperature and length of the flame is also employed. This design is aided by pumps, valves, and lines protected with insulation and vacuum-jacketed construction and piping, and by temperature-controlled fuel tanks featuring exterior insulation, a triple-wall double vacuum-jacketed shell insulated by evacuated porous or multi-layer insulation in between the walls, liquid fuel cryocoolers that use helium to chill the liquid hydrogen and argon or nitrogen to chill the liquid oxygen, a boil-off re-liquefaction cryocooler with phase correction, a gas or vacuum tank and fuel line purging system, and multiple pressure relief valves vented to the exterior on every tank. In this design the fuel enters the pumps and fuel line feeds to the combustor at known, controllable, and constant temperatures and in a known phase and state, regardless of exterior air temperatures, air pressure, and weather. This is an advance over modern cryogenic fuel tank designs, although NASA has been working on some similar designs recently, new LNG tanker ships and some modern helium tanker trucks now employ triple-walled shell construction and can be equipped with cryocoolers and boil-off liquefaction systems, and most large cryogenic fuel tanks have at least one pressure relief valve.

The end result is a totally emissions-free design, the first workable zero emissions gas turbine in the world. The exhaust is just steam, water vapor, oxygen, and, at high altitudes and cool temperatures, ice crystals. It is a design that has the potential to increase aircraft range and cruising altitude, to increase the power output of marine turbines, and to increase the power output of power generation and industrial combustion turbines in engines of an equivalent size, weight, and fuel consumption.

This design is becoming increasingly practical as “green” hydrogen and oxygen production plants that use electrolysis to separate water are starting to appear all over the world this year, plants that employ wind energy, solar energy, hydroelectric power, and nuclear energy as their power source; as new and more efficient means of storage and transport of these fuels appear; and as plans to make these fuels available at major airports, rail terminals, marine depots, and power generation facilities are being planned. These are all brand new developments that have taken place in just the past year or two.

The end result is a totally emissions-free design, the first zero emissions gas turbine in the world. The exhaust is just steam, water vapor, oxygen, and, at high altitudes and cool temperatures, ice crystals.

1. This is the design of a new type of zero emissions turbine, suitable for use as an aerospace turbine, as an aeroderivative power generation gas turbine, and as a marine turbine, that runs on liquid hydrogen and liquid oxygen fuel and uses a liquid oxygen cooling system, producing an exhaust of steam, water vapor, ice crystals, and pure oxygen.

2. This is a unique gas turbine design in that it does not require any air intake or compressor, unlike every other working gas turbine design in the world today. Instead, it creates the pressure used to turn the turbine solely by burning and gasifying its fuel in the combustor. Unlike modern steam turbines, it does not require a massive independent boiler to create steam pressure. As such, it can use greatly simplified shaft and auxiliary drive designs, and can create much more usable power with much less fuel, at any altitude, at any depth in the ocean, in any kind of weather condition, at any foreseeable temperature, and practically irregardless of bird strikes and interference from other airborne objects.

3. This design uses a unique system of liquid hydrogen and liquid oxygen fuel pumps and tanks driven by electric motors that, in the aerospace turbofan design shown in the drawings, run on 28 volt DC current provided by a generator and APU unit and which employ their own three proprietary pump and lubrication systems and which, in the power generation and marine genset versions, may run on 120/240 volt AC current with similar differentiation between the three separate pump and lubrication systems. It does not use the more or less standard turbopumps that are found on every modern rocket engine that burns this type of fuel. This makes operation and cooling more predictable, more controllable, more reliable, and more stable for long-term continuous, uninterrupted, and often variable rate usage that can last for hours, days, weeks, and months at a time and which, in that way, will tend to be markedly dissimilar from the 30-second one-time full-power blast that is standard operating procedure in most rocket designs of this type today.
